(19) United States
(12) Patent Application Publication
(10) Pub. No.: US 2015/0334024 A1
(43) Pub. Date: Nov. 19, 2015

(54) Controlling Data Rates of Data Flows Based on Information Indicating Congestion

(71) Applicants: Jeffrey Clifford Mogul, Menlo Park, CA (US); Puneet Sharma, Palo Alto, CA (US); Sujata Banerjee, Palo Alto, CA (US); Kevin Christpher Webb, San Diego, CA (US); Praveen Yalagandula, San Francisco, CA (US)

(72) Inventors: Jeffrey Clifford Mogul, Menlo Park, CA (US); Puneet Sharma, Palo Alto, CA (US); Sujata Banerjee, Palo Alto, CA (US); Kevin Christpher Webb, San Diego, CA (US); Praveen Yalagandula, San Francisco, CA (US)

(21) Appl. No.: 14/395,612

(22) PCT Filed: Apr. 20, 2012
(86) PCT No.: PCT/US2012/034451

§ 371 Date: Oct. 20, 2014

(51) Int. Cl. H04L 12/803; H04L 12/825; H04L 12/851

(52) U.S. Cl. CPC H04L 47/122; H04L 47/24; H04L 47/263

(57) ABSTRACT

A controller receives information from congestion detectors in a network, the information indicating that points in the network are congested due to data flows in the network. The controller controls data rates of the data flows based on the information.

### BACKGROUND

A network can be used to communicate data among various network entities. A network can include switches, links that interconnect the switches, and links that interconnect switches and network entities. Congestion at various points in the network can cause reduced performance in communications through the network.

### BRIEF DESCRIPTION OF THE DRAWINGS

Some embodiments are described with respect to the following figures:

FIG. 1 is a block diagram of an example arrangement that includes a congestion controller according to some implementations;

FIG. 2 is a schematic diagram of a congestion controller according to some implementations;

FIGS. 3 and 4 are flow diagrams of congestion management processes according to various implementations;

FIG. 5 is a block diagram of an example system that incorporates some implementations; and

FIG. 6 is a block diagram of a network entity according to some implementations.

### DETAILED DESCRIPTION

Multiple groups of network entities can share a physical network, where each group of network entities can be considered to be independent of other groups of network entities, in terms of functional and/or performance specifications. A network entity can be a physical machine or a virtual machine. In some implementations, a group of network entities can be part of a logical grouping referred to as a virtual network. An example of a virtual network is a virtual local area network (VLAN). In some examples, a service provider such as a cloud service provider can manage and operate virtual networks.

Virtual machines are implemented on physical machines. Examples of physical machines include computers (e.g. server computers, desktop computers, portable computers, tablet computers, etc.), storage systems, and so forth. A virtual machine can refer to a partition or segment of a physical machine, where the virtual machine is provided to virtualize or emulate a physical machine. From a perspective of a user or application, a virtual machine looks like a physical machine.

Although reference is made to virtual networks as being groups of network entities that can share a network, it is noted that techniques or mechanisms according to some implementations can be applied to other types of groups of network entities, such as groups based on departments of an enterprise, groups based on geographic locations, and so forth.

If a network is shared by a relatively large number of network entity groups, congestion may result at various points in the network such that available bandwidth at such network points may be insufficient to accommodate the traffic load of the network entity groups that share the network. A “point” in a network can refer to a link, a collection of links, or a communication device such as a switch. A “switch” can refer to any intermediate communication device that is used to communicate data between at least two other entities in a network. A switch can refer to a layer 2 switch, a layer 3 router, or any other type of intermediate communication device.

A network may include congestion detectors for detecting congestion at corresponding network points. The congestion detectors can provide congestion notifications to sources of data flows (also referred to as “network flows”) contributing to congestion. A congestion notification refers to an indication (in the form of a message, portion of a data unit, signal, etc.) that specifies that congestion has been detected at a corresponding network point. A “data flow” or “network flow” can generally refer to an identified communication of data, where the identified communication can be a communication session between a pair of network entities, a communication of a Transmission Control Protocol (TCP) connection (identified by TCP ports and Internet Protocol (IP) addresses, for example), a communication between a pair of IP addresses, and/or a communication between groups of network entities.

In some examples, a congestion notification can be used at a source of a data flow to reduce the data rate of the data flow. Reducing the data rate of a data flow is also referred to as rate-limiting or rate-reducing the data flow. However, individually applying rate-reduction to corresponding data flows at respective sources of the data flows may be inefficient and may lead to excessive overall reduction of data rates, which can result in overall reduced network performance. For example, when a switch detects congestion at a particular network point caused by multiple data flows from multiple sources, the switch can send congestion notifications to each of the multiple sources, which can cause each of the multiple sources to rate-reduce the corresponding data flow. However, applying rate reduction on every one of the data flows may exceed the overall data rate reduction that has to be performed to remove congestion at the particular network point.

In accordance with some implementations, a congestion controller is used for controlling data rates of data flows that contribute to congestion in a network. The congestion controller can consider various input information in performing the control of the data rates. The input information can include congestion notifications from congestion detectors in the network regarding congestions at one or multiple points in the network. Such congestion notifications can be used by the congestion controller to ascertain congestion at multiple network points.

Further input information that can be considered by the congestion controller includes priority information regarding relative priorities of data flows. A “priority” of a data flow can refer to a priority assigned to the data flow, or a priority assigned to a source of the data flow.

Using a congestion controller to control data rates of data flows in a network allows for the control to be based on a more global view of the state of the network, rather than data rate control that is based on just congestion at a particular point in the network. This global view can consider congestion at multiple points in the network. Also, the controller can consider additional information in performing data rate control, such as information relating to relative priorities of the data flows as noted above. Additionally, there can be flexibility in how data rate control is achieved—for example, data rate control can be performed at sources (e.g. network entities) of data flows, or alternatively, data rate control can be performed at other reaction points that can be further downstream of sources (such other reaction points can include switches or other intermediate communication devices).

Although reference is made to a “congestion controller” that is able to control data rates of data flows to reduce congestion, note that such congestion controller can perform tasks in addition to congestion control, such as activating switches that may have been previously off. More generally, reference can be made to a “controller.”

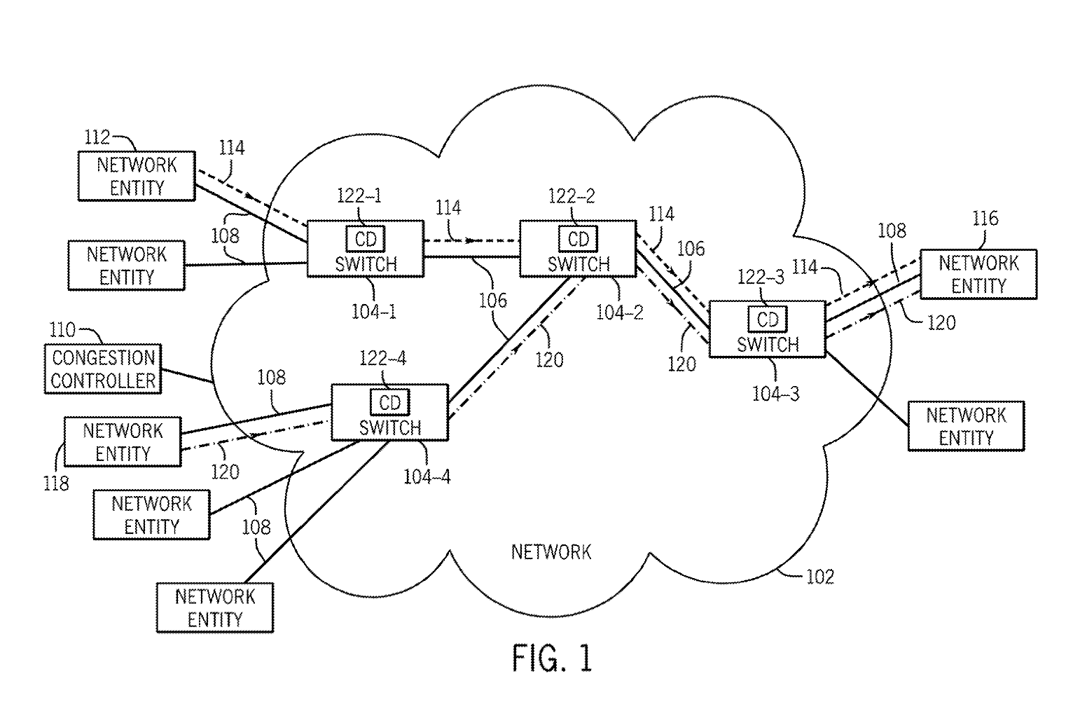

FIG. 1 is a block diagram of an example arrangement that includes a network 102 and various network entities connected to the network 102. The network entities are able to communicate with each other through the network 102. The network 102 includes switches 104 (switches 104-1, 104-2, 104-3, and 104-4 are shown) that are used for communicating data through the network 102. Links 106 interconnect the switches 104, and links 108 interconnect switches 104 to corresponding network entities.

In addition, a congestion controller 110 is provided to control data rates of data flows in the network 102, in response to various input information, including notifications of congestion at various points in the network 102. The congestion controller 110 can be implemented on a single machine (e.g. a central computer), or the congestion controller 110 can be distributed across multiple machines. In implementations where the congestion controller 110 is distributed across multiple machines, such multiple machines can include one or multiple central computers and possibly portions of the network entities.

In such distributed implementations, the congestion controller 110 can have functionality implemented in the central computer(s) and functionality implemented in the network entities. In some examples, the functionality of the congestion controller 110 implemented in the central computer(s) can pre-instruct or pre-configure the network entities to perform programmed tasks in response to input information that includes the congestion notifications and other information discussed above.

In a specific example shown in FIG. 1, a first source network entity 112 can send data units in a data flow 114 through the network 102 to a destination network entity 116. The data flow 114 can traverse through switches 104-1, 104-2, and 104-3. A “data unit” can refer to a data packet, a data frame, and so forth.

A second source network entity 118 can send data units in a data flow 120 through switches 104-4, 104-2, and 104-3 to the destination network entity 116.

In some examples, each of the switches 104 can include a respective congestion detector 122 (122-1, 122-2, 122-3, 122-4 shown in FIG. 1). A congestion detector 122 can detect congestion at a corresponding network point (which can include a link, a collection of links, or an intermediate communication device such as a switch) in the network 102. In response to detection of congestion at a network point, the congestion detector 122 can send a congestion notification to the congestion controller 110. The congestion controller 110 can use congestion notifications from various congestion detectors to control data rates of data flows in the network 102.

As an example, the congestion detector 122-2 in the switch 104-2 may have detected congestion at the switch 104-2. In the example discussed above, both the data flows 114 and 120 pass through the congested switch 104-2. Such data flows 114 and 120 can be considered to contribute to the congestion at the switch 104-2. In response to detecting the congestion, the congestion detector 122-2 in the switch 104-2 can send a congestion notification(s) to the congestion controller 110. If just one congestion notification is sent to the congestion controller 110, then the congestion notification can include information identifying at least one of the multiple data flows 114 and 120 that contributed to the congestion. In other examples where multiple congestion notifications are sent by the congestion detector 122-2 to the congestion controller 110, then each corresponding congestion notification can include information identifying a corresponding one of the data flows 114 and 120 that contributed to the congestion.

In some examples, a congestion notification can be a congestion notification message (CNM) according to an IEEE (Institute of Electrical and Electronics Engineers) 802.1Qau protocol. The CNM can carry a prefix that contains information to allow the recipient of the CNM to identify the data flow(s) that contributed to the congestion. The CNM can also include an indication of congestion severity, where congestion severity can be one of multiple predefined severity levels.

In other implementations, other forms of congestion notifications can be used.

The congestion detector 122 in a switch 104 can be implemented with a hardware rate limiter. In some examples, a hardware rate limiter can be associated with a token bucket that has a predefined number of tokens. Each time the rate limiter detects associated traffic passing through the switch, the rate limiter deducts one or multiple tokens from the token bucket according to the quantity of the traffic. If there are no tokens left, then the hardware rate limiter can provide a notification of congestion. Note that a hardware rate limiter can act as both a detector of congestion and a policer to drop data units upon detection of congestion. In accordance with some implementations, hardware rate limiters are used in their role as congestion detectors.

In other implementations, the congestion detector 122 can be implemented as a detector associated with a traffic queue in a switch. The traffic queue is used to temporarily store data units that are to be communicated by the switch through the network 102. If the amount of available entries in the traffic queue drops below some predefined threshold, then the congestion detector 122 sends a congestion notification.

Although FIG. 1 shows congestion detectors 122 provided in respective switches 104, it is noted that congestion detectors 122 can alternatively be provided outside of switches.

FIG. 2 is a schematic diagram of inputs and outputs of the congestion controller 110. The congestion controller 110 receives congestion notifications (202) from various congestion detectors 122 in the network 102. The congestion notifications contain information that allow the congestion controller 110 to identify data flows that contribute to congestion at respective points in the network 102.

As further shown in FIG. 2, the congestion controller 110 can also receive (at 204) priority information indicating relative priorities of data flows in the network 102. As noted above, a “priority” of a data flow can refer to a priority assigned to the data flow, or a priority assigned to a source of the data flow. Some data flows can have higher priorities than other data flows. In some examples, the priority information (204) can be provided to the congestion controller 110 by sources of data flows (e.g. the network entities of FIG. 1). In alternative examples, the congestion controller 110 can be pre-configured with priorities of various network entities or groups of network entities (e.g. virtual networks) that are able to use the network 102 to communicate data. A data flow associated with a particular network entity or a particular group is assigned the corresponding priority. In the latter examples, the priority information 204 can be input into the congestion controller 110 as part of a configuration procedure of the congestion controller 110 (such as during initial startup of the congestion controller 110 or during intermittent configuration updates of the congestion controller 110).

In some implementations, the relative priority of a data flow may be implied by the service class of the data flow. The service class of a data flow can specify, for example, a guaranteed or target bandwidth for that flow, or maximum values on the network latency for packets of that flow, or maximum values on the rate of packet loss for that flow. Flows with more demanding service classes may be given priority over other flows with less demanding service classes.

Based on the congestion notifications (202) from various congestion detectors 122 in the network 102, the congestion controller 110 is able to determine the congestion states of various points in the network 102. In some implementations, the congestion controller 110 may be able to determine the congestion states of only a subset of the various points in the network 102. Based on this global view of the congestion state of the various network points, the congestion controller 110 is able to control data rates of data flows that contribute to network congestion. Note also that the congestion controller 110 can also perform data rate control that considers relative priorities of data flows.

Controlling data rates of data flows can involve reducing the data rates of all of the data flows that contribute to congestion at network points, or reducing the data rate of at least one data flow while allowing the data rate of at least another data flow to remain unchanged (or be increased). Controlling data rates by the congestion controller 110 can involve the congestion controller 110 sending data-rate control indications 206 to one or multiple reaction points in the network. The reaction points can include network entities that are sources of data flows. In other examples, the reaction points can be switches or other intermediate communication devices that are in the routes of data flows whose data rates are to be controlled. More generally, a reaction point can refer to a communication element that is able to modify the data rate of a data flow.

The data rate control indications 206 can specify that the data rate of at least one data flow is to be reduced, while the data rate of at least another data flow is not to be reduced. In some implementations, the congestion controller 110 can use the priority information of data flows (204) to decide which data rate(s) of corresponding data flows is (are) to be reduced. The data rate of a lower priority data flow can be reduced, while the data flow of a higher priority data flow is not reduced.

In further implementations, the congestion controller 110 can also output re-routing control indications 208 to re-route at least one data flow from an original route through the network 102 to a different route through the network 102. The ability to re-route a data flow from an original route to a different route through the network 102 is an alternative or additional choice that can be made by the congestion controller 110 in response to detecting congested network points. Re-routing a data flow allows the data flow to bypass a congested network point. To perform re-routing, the congestion controller 110 can identify a route through the network 102 (that traverses through various switches and corresponding links) that is uncongested. Determining a route that is uncongested can involve the congestion controller 110 analyzing congestion notifications from various congestion detectors 122 in the network 102 to determine which switches are not associated with congested network points. Lack of a congestion notification from a congestion detector can indicate that the corresponding network point is uncongested. Based on the awareness of the network topology of the network 102, the congestion controller 110 can make a determination of a route through network points that are uncongested. The identified uncongested route can be used by the congestion controller 110 to re-route a data flow in some implementations.

The re-routing control indications 208 can include information that can be used by switches to update routing tables in the switches for a particular data flow. A routing table includes multiple entries, where each entry can correspond to a respective data flow. An entry of a routing table can identify one or multiple ports of a switch to which incoming data units of the particular data flow are to be routed. To change the route of the particular data flow from an original route to a different route, entries of multiple routing tables in corresponding switches may be updated based on the re-routing control indications 208.

Although FIG. 2 shows priority information 204 as an input to the congestion controller 110, it is noted that in other implementations, priority information is not provided to the congestion controller 110. In some examples, the congestion controller 110 can even change priorities of data flows in response to congestion notifications, such as to reduce a priority of at least one data flow to reduce congestion.

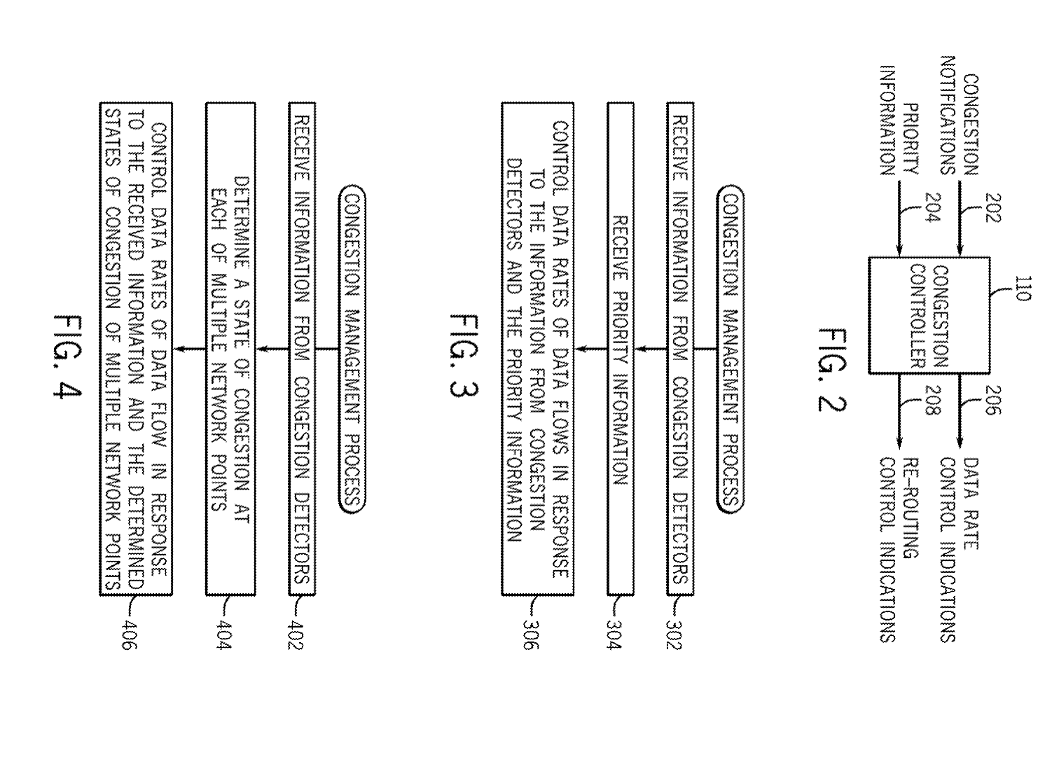

FIG. 3 is a flow diagram of a congestion management process according to some implementations. The process of FIG. 3 can be performed by the congestion controller 110, for example. The congestion controller 110 receives (at 302) information from congestion detectors 122 in a network, where the information can include congestion notifications (e.g. 202 in FIG. 2) that indicate points in the network that are congested due to data flows in the network. The congestion controller 110 can further receive (at 304) priority information (e.g. 204 in FIG. 2) indicating relative priorities of various data flows. The congestion controller 110 controls (at 306) data rates of the data flows based on the information received at 302 and 304.

FIG. 4 is a flow diagram of a process according to alternative implementations. In the FIG. 4 process, the priority information (e.g. 204 in FIG. 2) is not considered in performing data rate control of data flows that contribute to congestion at network points. The process of FIG. 4 can also be performed by the congestion controller 110, for example. Similar to the process of FIG. 3, the process of FIG. 4 receives (at 402) information from congestion detectors 122 in a network, where such information can include congestion notifications (e.g. 202 in FIG. 2). In some implementations, congestion notifications 202 are sent upon detection by respective congestion detectors 122 of congested network points. The lack of a congestion notification from a particular congestion detector 122 indicates that the associated network point is not congested.

The congestion controller 110 is able to determine (at 404), from the information received at 402, the states of congestion at various network points. The determined states of congestion can include a first congestion state (associated with a first network point) that indicates that the first network point is not congested, and can include at least a second congestion state (associated with at least a second network point) indicating that at least the second network point is congested. There can be multiple different second congestion states indicating different levels of congestion.

The congestion controller 110 then controls (at 406) data rates of data flows in response to the received information from the congestion detectors and that considers the states of congestion occurring at multiple network points.

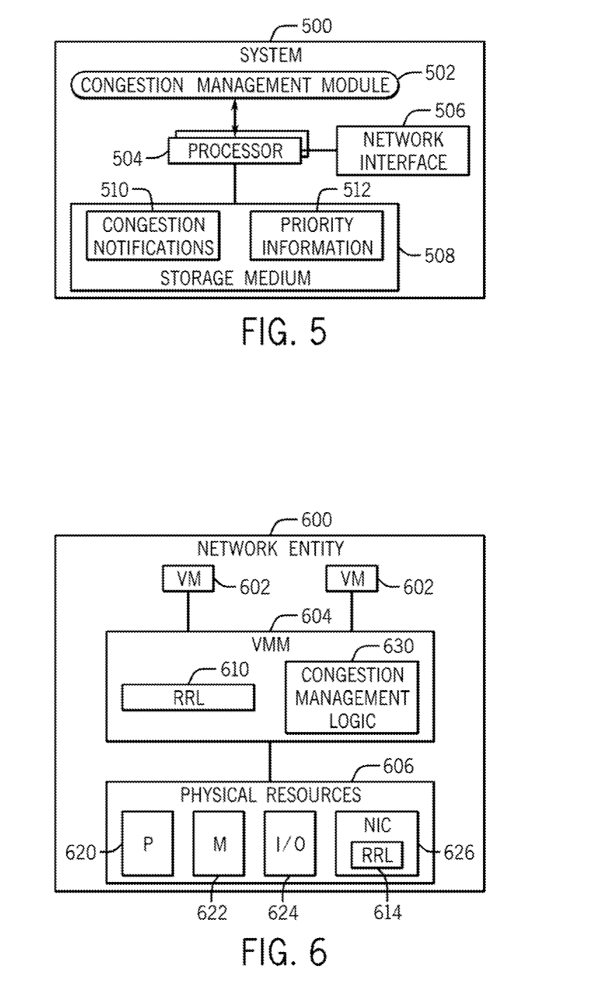

FIG. 5 is a block diagram of an example system 500 according to some implementations. The system 500 can represent the congestion controller 110 of FIG. 1 or 2. The system 500 includes a congestion management module 502 that is executable on one or multiple processors 504. The one or multiple processors 504 can be implemented on a single machine or on multiple machines.

The processor(s) 504 can be connected to a network interface 506, to allow the system 500 to communicate over the network 102. The processor(s) 504 can also be connected to a storage medium (or storage media) 508 to store various information, including received congestion notifications 510, and priority information 512.

FIG. 6 is a block diagram of an example network entity 600, such as one of the network entities depicted in FIG. 1. The network entity 600 include multiple virtual machines 602. The network entity 600 can also include a virtual machine monitor (VMM) 604, which can also be referred to as a hypervisor. Although the network entity 600 is shown as having virtual machines 602 and the VMM 604, it is noted that in other examples, the network entity 600 is not provided with virtual elements including the virtual machines 602 and VMM 604.

The VMM 604 manages the sharing (by virtual machines 602) of physical resources 606 in the network entity 600. The physical resources 606 can include a processor 620, a memory device 622, an input/output (I/O) device 624, a network interface card (NIC) 626, and so forth.

The VMM 604 can manage memory access, I/O device access, NIC access, and CPU scheduling for the virtual machines 602. Effectively, the VMM 604 provides an interface between an operating system (referred to as a “guest operating system”) in each of the virtual machines 602 and the physical resources 606 of the network entity 600. The interface provided by the VMM 604 to a virtual machine 602 is designed to emulate the interface provided by the corresponding hardware device of the network entity 600.

Rate reduction logic (RRL) 610 can be implemented in the VMM 604, or alternatively, rate reduction logic 614 can be implemented in the NIC 626. The rate reduction logic 610 and/or rate reduction logic 614 can be used to apply rate reduction in response to the data rate control indications (e.g. 206 in FIG. 2) output by of the congestion controller 110. In implementations where the congestion controller 110 of FIG. 1 or FIG. 2 is distributed across multiple machines including network entities, such as the network entity 600 of FIG. 6, the VMM 604 can also be configured with congestion management logic 630 that can perform some of the tasks of the congestion controller 110 discussed above.

In other examples, instead of providing the congestion management logic 630 in the VMM 604, the congestion management logic 630 can be provided as another module in the network entity 600.

Machine-readable instructions of modules described above (including 502, 602, 604, 610, and 630 of FIG. 5 or 6) can be loaded for execution on a processor or processors (e.g. 504 or 620 in FIG. 5 or 6). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a controller, information from congestion detectors in a network, the information indicating that points in the network are congested due to data flows in the network; and
controlling, by the controller, data rates of the data flows based on the information, where the controlling considers relative priorities of the data flows and causes reduction of a data rate of at least a first one of the data flows, without reducing a data rate of at least a second one of the data flows.

2. The method of claim 1, wherein the receiving and controlling are performed by the controller implemented on a machine.

3. The method of claim 1, wherein the receiving and controlling are performed by the controller distributed across a plurality of machines.

4. The method of claim 1, wherein receiving the information from the congestion detectors comprises receiving the information from rate limiters in switches.

5. The method of claim 1, wherein receiving the information from the congestion detectors comprises receiving the information based on usage of traffic queues in switches.

6. The method of claim 1, wherein receiving the information comprises receiving congestion notifications from congestion detectors in the network.

7. The method of claim 6, wherein receiving the congestion notifications comprises receiving congestion notification messages according to an IEEE 802.1Qau protocol.

8. The method of claim 1, wherein the controlling further comprises:
re-routing at least one of the data flows from a first route through the network to a second, different route through the network.

9. The method of claim 8, further comprising:
identifying, based on the received information, a route that is uncongested, wherein the second route is the identified route.

10. A controller comprising:
at least one processor to:
receive information from congestion detectors in a network, the information indicating that points in the network are congested due to data flows in the network;
determine, based on the received information, congestion states of a plurality of network points; and
control data rates of the data flows based on the congestion states of the plurality of network points.

11. The controller of claim 10, wherein the at least one processor is to further:
send data rate control indications to reaction points to control the data rates of the data flows.

12. The controller of claim 11, wherein the reaction points are selected from the group consisting of data flow sources and intermediate communication devices.

13. The controller of claim 10, wherein the at least one processor is to further send re-route control indications to re-route a particular one of the data flows from a first route through the network to a second, different route through the network.

14. The controller of claim 10, wherein the at least one processor is to further change a priority of at least one of the data flows in response to the information from the congestion detectors.

15. An article comprising at least one machine-readable storage medium storing instructions that upon execution cause a controller to:
receive information from congestion detectors in a network, the information indicating that points in the network are congested due to data flows in the network; and
control data rates of the data flows based on the information, where the controlling considers relative priorities of the data flows and causes reduction of a data rate of at least a first one of the data flows, without reducing a data rate of at least a second one of the data flows.
